(19) United States
(12) Patent Application Publication
(10) Pub. No.: US 2026/0121809 A1
(43) Pub. Date: Apr. 30, 2026

(54) EARLY SOUNDING REFERENCE SIGNAL (SRS) FOR LOWER LAYER TRIGGERED MOBILITY (LTM)

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/933,900

(22) Filed: Oct. 31, 2024

(51) Int. Cl. H04L 5/00; H04W 56/00; H04W 72/231; H04W 72/51

(52) U.S. Cl. CPC H04L 5/0051; H04W 56/0045; H04W 72/231; H04W 72/51

(57) ABSTRACT

Certain aspects of the present disclosure provide a method for wireless communications at a wireless node such as a user equipment (UE). The UE may transmit, to a source cell, layer 3 and/or layer 1 measurements for the source cell and a set of neighbor cells. The UE may receive, from the source cell after transmitting the layer 3 and/or layer 1 measurements, signaling triggering the UE to transmit early sounding reference signals (SRSs) (e.g., while communicating with the source cell) to one or more neighbor cells of the set of neighbor cells. The UE may transmit the early SRSs to the one or more neighbor cells while the UE is connected with the source cell.

### BACKGROUND

### Field of the Disclosure

Aspects of the present disclosure relate to wireless communications, and more particularly, to techniques for managing sounding reference signal (SRS) transmissions.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes transmitting, to a source cell, measurements for at least one of: the source cell or a set of neighbor cells; receiving, from the source cell after transmitting the measurements, first signaling triggering the UE to transmit early sounding reference signals (SRSs) to one or more neighbor cells of the set of neighbor cells; and transmitting the early SRSs to the one or more neighbor cells while the UE is connected with the source cell.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network, in accordance with certain aspects of the present disclosure.

FIG. 2 depicts an example disaggregated base station (BS) architecture, in accordance with certain aspects of the present disclosure.

FIG. 3 depicts aspects of an example BS and an example user equipment (UE), in accordance with certain aspects of the present disclosure.

FIG. 4A, FIG. 4B, FIG. 4C, and FIG. 4D depict various example aspects of data structures for a wireless communications network, in accordance with certain aspects of the present disclosure.

FIG. 5 depicts an example scenario in which a UE is transferred (e.g., handed over) between source and target cells supported by different gNodeB (gNB) distributed units (DUs) under a same (e.g., common) gNB central unit (CU), in accordance with certain aspects of the present disclosure.

FIG. 6 depicts an example scenario in which a UE is transferred (e.g., handed over) between source and target cells supported by radio units (RUs) of a same gNB-DU under a same (e.g., common) gNB-CU, in accordance with certain aspects of the present disclosure.

FIG. 7 depicts an example scenario in which a UE is transferred (e.g., handed over) between source and target cells supported by RUs of different gNB-DUs under a same (e.g., common) gNB-CU, in accordance with certain aspects of the present disclosure.

FIG. 8 depicts an example scenario in which a UE is transferred (e.g., handed over) between source and target cells supported by RUs of a same gNB-DU, in accordance with certain aspects of the present disclosure.

FIG. 9 depicts example call flow diagram illustrating communication among different devices for managing early sounding reference signal (SRS) transmissions, in accordance with certain aspects of the present disclosure.

FIG. 10 depicts example methods for wireless communications at a UE for managing early SRS transmissions, in accordance with certain aspects of the present disclosure.

FIG. 11 depicts example communications device configured for managing early SRS transmissions, in accordance with certain aspects of the present disclosure.

### DETAILED DESCRIPTION

Aspects of the present disclosure relate to lower layer triggered mobility (LTM) procedures.

A user equipment (UE) may move between a set of cells. For example, a handover (mobility) of the UE is a process of transferring an ongoing communication session of the UE from one cell (i.e., a gNodeB (gNB)) to another cell.

The UE may be configured with the cells that support mobility based on layer 1 (L1) (e.g., physical (PHY) layer) or layer 2 (e.g., medium access control (MAC) layer) signaling. The L1/L2 based mobility is known as an LTM procedure, which may enable a serving cell change via the L1/L2 signaling, while keeping configuration of upper layers and/or minimizing changes of configuration of lower layers. This may help to reduce latency, overhead and interruption time during the handover.

The UE may be configured to monitor and measure multiple candidate target cells and, based on the measurements, the UE may move from a source cell to a target cell, via a dynamically signaled L1/L2-based mobility command from the source cell. The mobility command may include uplink timing information for the target cell.

After the handover to the target cell has been completed, the UE may then send sounding reference signals (SRSs) to the target cell. The target cell may estimate uplink channel quality using the received SRSs from the UE, and may manage further resource scheduling and beam management. For example, the SRSs provide information to the target cell about a channel over a full bandwidth and using this information, the target cell may take decisions for resource allocation for the UE which has better channel quality as compared to other bandwidth regions.

There may be a time gap of around 20 to 40 milliseconds (ms) between the completion of the handover to the target cell and SRS transmissions from the UE to the target cell. During this time gap, uplink/downlink transmissions from/to the UE are typically not scheduled. This may result in data being accumulated in the UE and the target cell buffers that has to be transmitted, and this data accumulation may increase latency and cause data interruption during the handover.

Also, in some cases, an uplink grant for the UE from the target cell may be conservative and based on low modulation and coding scheme (MCS) values (e.g., MCS 0 with 1 layer), which may also increase the latency and, thus, impact user experience.

Techniques proposed herein configure the UE to transmit early SRS transmissions to the target cell, before the handover of the UE from the source cell to the target cell has been completed. These early SRS transmissions may enable the UE to receive uplink/downlink scheduling information associated with the target cell before the handover to the target cell has been completed. For example, the target cell may use the early SRS transmissions to perform initial uplink/downlink scheduling for the UE, and the initial uplink/downlink scheduling information is provided to the UE by the target cell via the source cell prior to the handover to the target cell. As a result, any accumulated buffer data at buffers of the UE or the target cell can be sent to the target cell by the UE or the UE by the target cell earlier, which may help reduce data interruption and latency during the handover.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

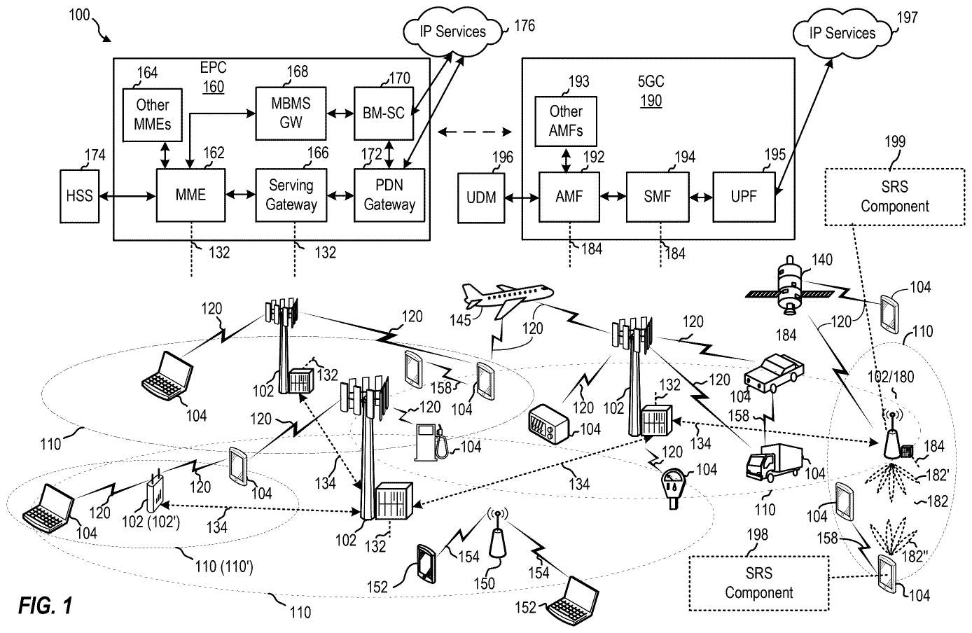

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

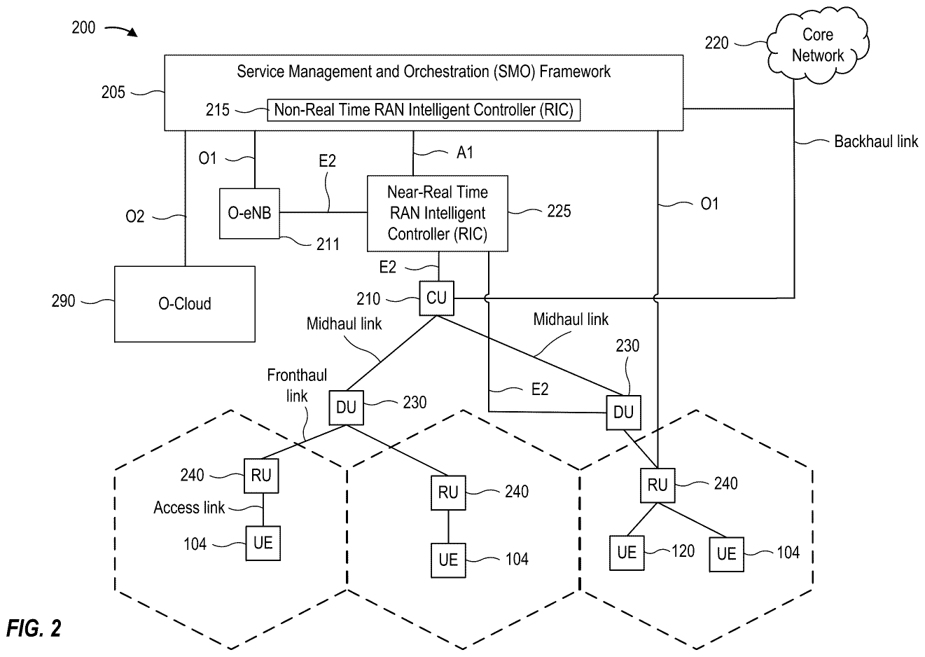

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182″. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

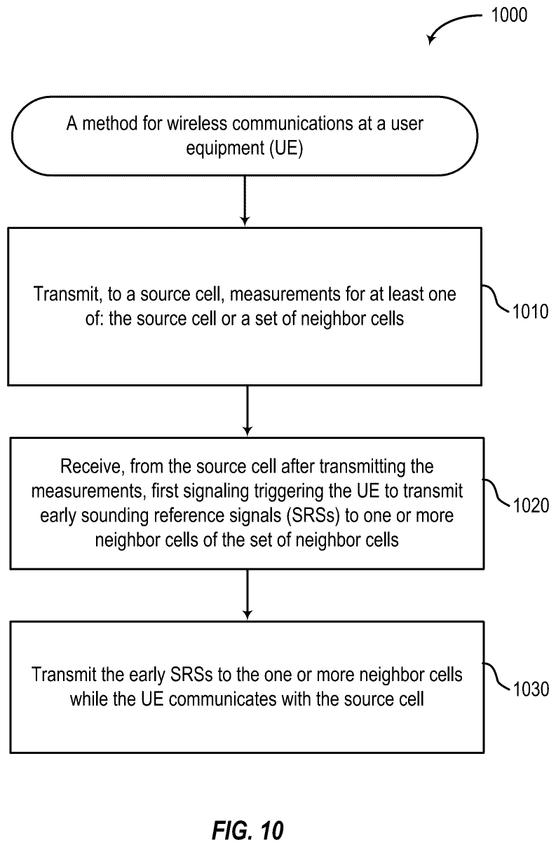

Wireless communication network 100 further includes sounding reference signal (SRS) component 198, which may be configured to perform method 1000 of FIG. 10. Wireless communication network 100 further includes SRS component 199, which may be configured to perform method 1000 of FIG. 10.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 245, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

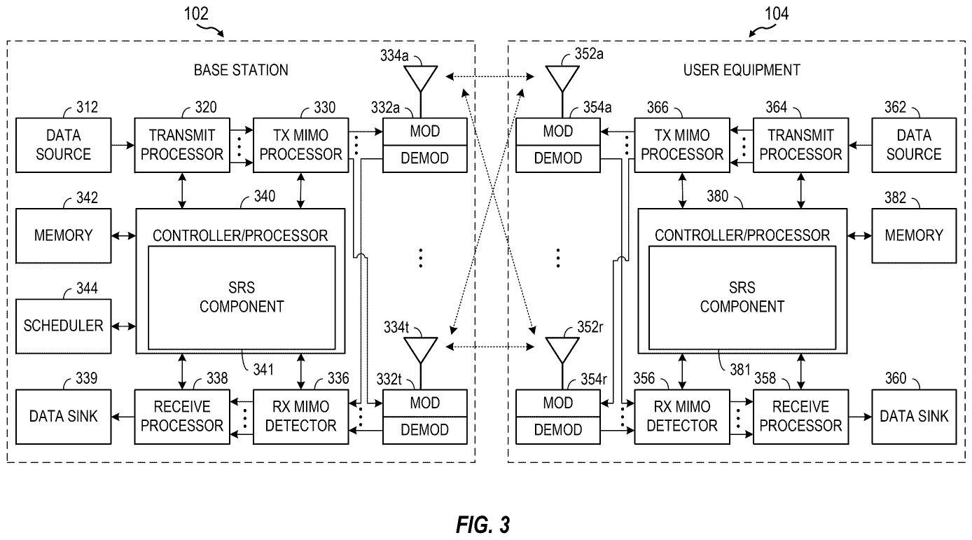

FIG. 3 depicts aspects of an example BS 102 and a UE 104.

Generally, BS 102 includes various processors (e.g., 324, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes SRS component 341, which may be representative of SRS component 199 of FIG. 1. Notably, while depicted as an aspect of controller/processor 340, SRS component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes SRS component 381, which may be representative of SRS component 138 of FIG. 1. Notably, while depicted as an aspect of controller/processor 380, SRS component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of providing or outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

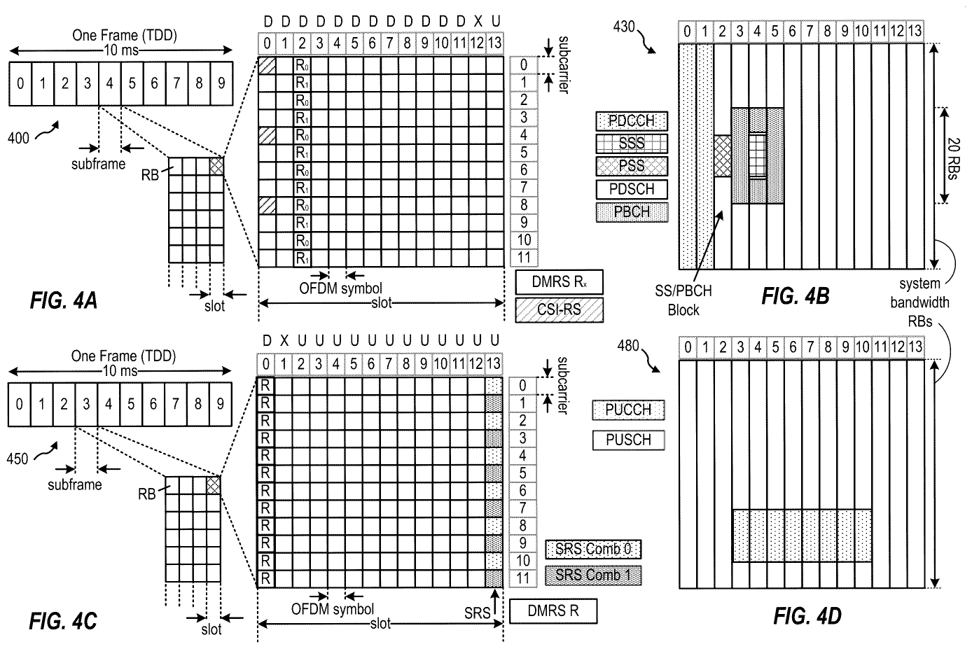

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Mmwave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz”band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Sounding Reference Signal (SRS)

A sounding reference signal (SRS) is a reference signal used to measure an uplink channel. A gNodeB (gNB) may measure the uplink channel based on the SRS sent by a user equipment (UE) to determine channel conditions or a quality of the uplink channel and schedule uplink resources. An SRS resource set may be used to transmit (e.g., broadcast) the SRS using a plurality of antenna ports (such as, port 0, port 1, etc.). The SRS resource set may be configured for different types of usages including a codebook based transmission and a non-codebook based transmission. One SRS resource set may include one or more SRS resources for one or more antenna ports.

In communications systems, the UE can be configured for sending the SRS on 1, 2 or 4 antenna ports for uplink link adaptation. The SRS can be configured to use 1, 2 or 4 symbols in a time domain. The UE may also transmit the SRS using multiple antenna ports for downlink link adaptation when channel reciprocity is available, e.g., for determining a downlink precoding matrix.

A multi-port SRS transmission may be the SRS transmitted by the UE using 2 or 4 antenna ports. In some cases, all ports (e.g., ports 0, 1, 2, and 3) are used within one single carrier (SC) frequency division multiple access (FDMA) symbol of one subframe on a same comb of subcarriers in a bandwidth using orthogonal sequences (e.g., up to 4 cyclically shifted versions of a common root sequence) for the multi-port SRS transmission.

A single-port SRS transmission can be transmitted from one of the antenna ports. There may be two modes for selecting an antenna port for the single-port SRS transmission, such as, closed loop antenna selection and open loop antenna selection. With closed loop antenna selection, the UE may select one of the antenna ports based on a gNodeB (gNB) indication. With open loop, it is up to the UE to select the antenna port.

In some cases, the SRS is transmitted using an interleaved frequency division multiple access (IFDMA) waveform, which is a special discrete Fourier transform (DFT) spread orthogonal frequency division multiplexing (DFT-S-OFDM) waveform. New radio (NR) supports use of the DFT-S-OFDM based waveform and use of a cyclic prefix (CP) orthogonal frequency division multiplexing (CP-OFDM) waveform for uplink transmissions, at least for uplink transmissions on bandwidths of up to 40 GHz.

### Overview of Handover Procedures

Handover (mobility) is a process of transferring an ongoing communication session of a user equipment (UE) from one cell (i.e., a gNodeB (gNB)) to another cell in connected state. The primary motivation behind handover is to ensure seamless connectivity and continuity of service for a user of the UE, especially while the user is on the move. Mobility can be categorized into two types: beam level mobility and cell level mobility.

The beam level mobility does not require explicit radio resource control (RRC) signaling to be triggered. It can be within a cell, or between cells (i.e., inter-cell beam management (ICBM)). The gNB provides the UE with measurement configuration for triggering channel and interference measurements and reports. Beam level mobility is then dealt with at lower layers by means of physical layer (PHY) and medium-access control (MAC) layer control signaling, and the UE does not require explicit RRC signaling to change to a target beam. The cell level mobility requires an explicit RRC signaling to be triggered.

New Radio (NR) supports different types of handover. The handover in NR is based on a handover mechanism in which the gNB controls the UE mobility based on UE measurement reporting. In the handover, a source gNB triggers handover by sending handover request to a target gNB and after receiving acknowledgement from the target gNB, the source gNB initiates handover by sending a handover command with target cell configuration. The UE accesses the target cell after the target cell configuration is applied.

In all handover types until Release 17, a serving cell change is triggered by layer 3 (L3) measurements and is done by RRC signaling (i.e., reconfiguration with synchronization information element) for change of a primary cell (PCell) and a primary secondary cell (PSCell). All cases require reconfiguration of upper layers (e.g., RRC) and/or resetting of lower layers (e.g., MAC and/or PHY) which leads to longer latency, larger overhead and longer interruption time than beam level mobility. Release 18 has introduced layer 1 (L1)/L2 based mobility also known as lower layer triggered mobility (LTM) to enable a serving cell change via L1/L2 signaling, while keeping configuration of the upper layers and/or minimizing changes of configuration of the lower layers. This helps to reduce the latency, overhead and interruption time during handover. The LTM supports both intra-distributed unit (DU) and intra-central unit (CU)-inter-DU mobility. During the LTM, user plane is continued whenever possible (e.g. intra-DU), without reset, with the target cell to avoid data loss and the additional delay of data recovery.

As per LTM procedure, the UE sends a Measurement Report message to the gNB. The gNB decides to use the LTM and initiates LTM candidate preparation. In a next step, the gNB transmits an RRC reconfiguration message to the UE including the configuration of one or multiple LTM candidate target cells. The UE stores the configuration of LTM candidate target cell(s) and transmits a RRCReconfigurationComplete message to the gNB. The UE may perform downlink (DL) synchronization and timing advance (TA) acquisition with candidate target cell(s) before receiving the LTM cell switch command. The UE performs L1 measurements on the configured LTM candidate target cell(s), and transmits lower-layer measurement reports to the gNB. The gNB decides to execute LTM cell switch to a target cell, and transmits a MAC control element (MAC-CE) triggering LTM cell switch. The UE switches to the configuration of the LTM candidate target cell. The UE performs random access procedure towards the target cell, if TA is not available. The UE indicates successful completion of the LTM cell switch towards the target cell.

### Example Handover Scenarios

A user equipment (UE) may move between a set of cells. The UE may be configured with a set sells that support mobility based on layer 1 (L1) (e.g., physical (PHY) layer) or layer 2 (e.g., medium access control (MAC) layer) signaling as opposed to higher layer (e.g., radio resource control (RRC)) signaling. The UE may be configured to monitor and measure cells within the set and, based on the measurements, the UE may move from a source cell to a target cell, via a dynamically signaled mobility command.

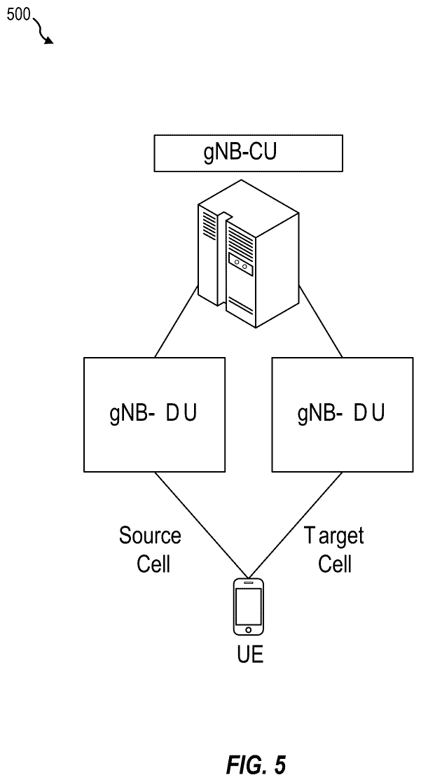

FIGS. 5, 6, 7, and 8 illustrate example handover scenarios in which aspects of the present disclosure may be practiced.

For example, a diagram 500 of FIG. 5 depicts a scenario in which a UE is transferred (e.g., handed over) between source and target cells, which are supported by different gNodeB (gNB) distributed units (DUs) under a same (e.g., common) gNB central unit (CU).

The gNB-CU may serve as a logical node hosting RRC, service data adaptation protocol (SDAP), and/or packet data convergence protocol (PDCP) protocols of a gNB that may control operations of one or more gNB-DUs.

The gNB-DU may serve as a logical node hosting radio link control (RLC), MAC, and PHY layers of the gNB, and its operation may be controlled by the gNB-CU. One gNB-DU may support one or multiple cells (but each cell may be supported by only one gNB-DU).

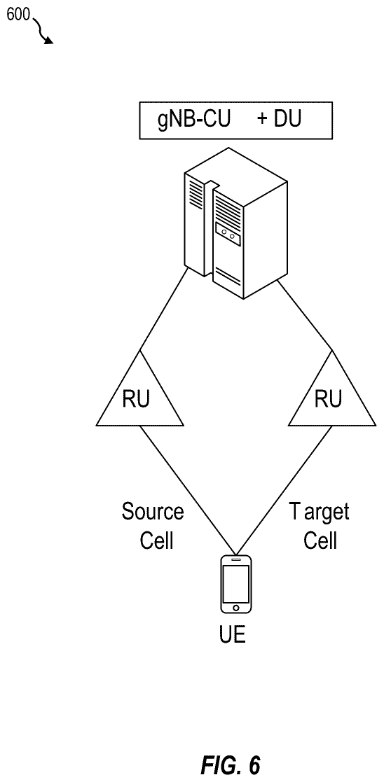

A diagram 600 of FIG. 6 depicts a scenario in which a UE is transferred between source and target cells, which are supported by radio units (RUs) of a same gNB-DU under a same gNB-CU. The RUs may only contain PHY layer logic and may be used (activated/de-activated) in a similar manner to carrier aggregation (CA), but the source and target cells may be on same carrier frequencies.

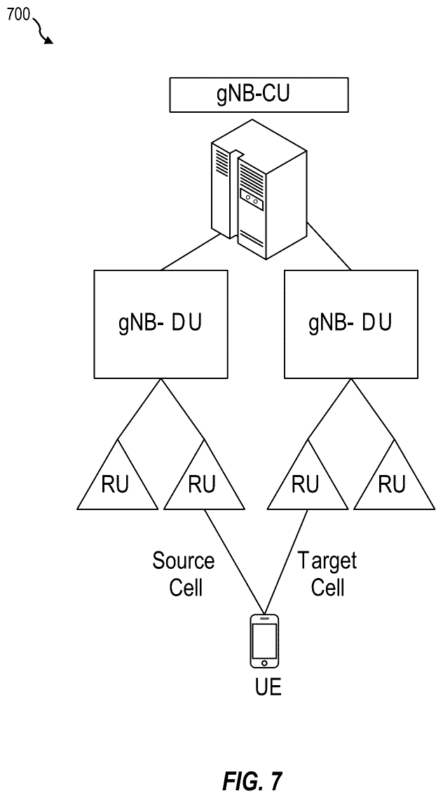

A diagram 700 of FIG. 7 depicts a scenario in which a UE is transferred between source and target cells, which are supported by RUs of different gNB-DUs under a same gNB-CU. In this scenario, the source and target cells may have non-collocated (e.g., in different DUs) PHY, MAC, and RLC logic, but common PDCP and RRC logic (e.g., the same CU). While L1/L2 signaling techniques described herein may be used for mobility, a data path from the PDCP to different RLCs present some control aspects that may be addressed by coordination between DUs.

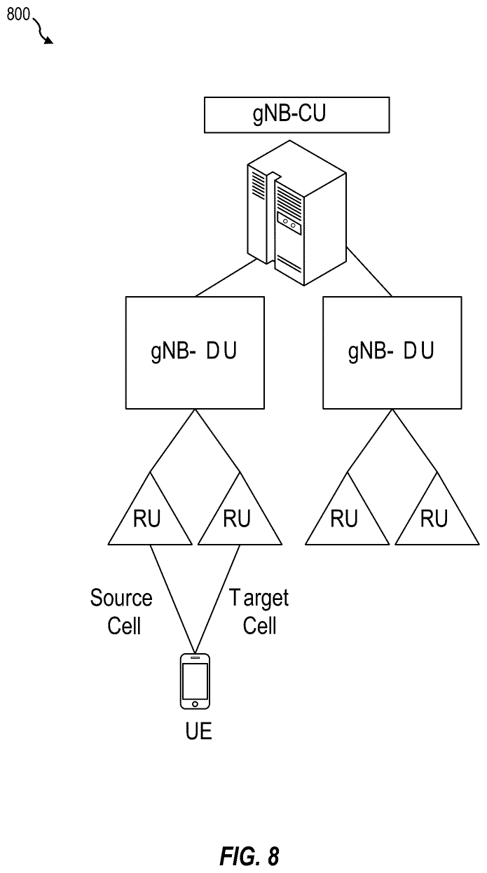

A diagram 800 of FIG. 8 depicts a scenario in which a UE is transferred between source and target cells, which are supported by RUs of a same gNB-DU. In this scenario, the source and target cells may be supported by (belong to) the same gNB-DU. So, L1/L2 mobility may be particularly attractive in this scenario, as the source and target cells can share MAC and upper layers (i.e., the same gNB-DU).

### Aspects Related to Early SRS for LTM

Techniques presented herein provide lower layer triggered mobility (LTM) signaling mechanisms that may help improve latency and improve efficiency with more usage of dynamic control signaling. For example, the techniques described herein make use of layer 1 (L1) (e.g., physical (PHY) layer) or layer 2 (e.g., medium access control (MAC) layer) signaling, as opposed to a higher layer (e.g., radio resource control (RRC)) signaling for a handover.

The techniques proposed herein configure a user equipment (UE) to transmit early sounding reference signal (SRS) transmissions to a target cell, before the handover of the UE from a source cell to the target cell has been completed. This may enable the UE to receive uplink/downlink scheduling information associated with the target cell before the handover to the target cell has been completed. For example, the target cell may use the early SRS transmissions to perform initial uplink/downlink scheduling for the UE, and the initial uplink/downlink scheduling information is provided to the UE by the target cell via the source cell prior to the handover to the target cell. So, any accumulated buffer data at buffers of the UE or the target cell can be sent to the target cell by the UE or the UE by the target cell earlier, and thus reduce data interruption and latency during the handover. The source cell and the target cell may be intra/inter frequency and/or inter radio access technology (RAT) cells.

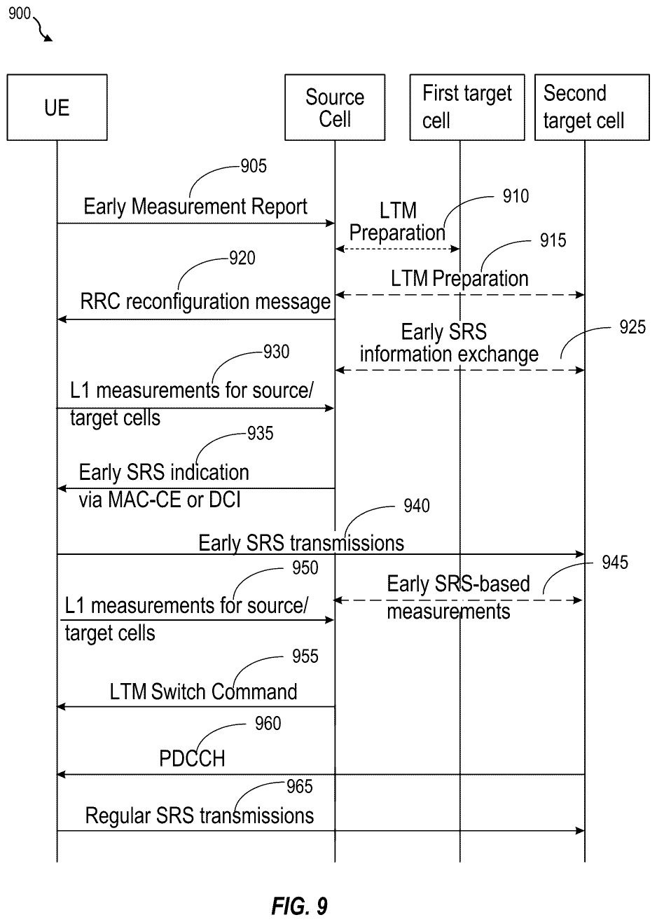

The techniques proposed herein for managing the early SRS transmissions may be understood with reference to FIG. 9-FIG. 11.

FIG. 9 depicts example call flow diagram 900 illustrating communication among wireless nodes such as a UE and different cells for managing early SRS transmissions. For example, the UE depicted in FIG. 9 may be an example of the UE 104 depicted and described with respect to FIG. 1 and FIG. 3. The source cell depicted in FIG. 9 may be an example of the source cell depicted and described with respect to FIGS. 5-8. The first target cell and the second target cell depicted in FIG. 9 may be an example of the target cell depicted and described with respect to FIGS. 5-8.

As indicated at 905, the UE transmits a message including an early measurement report to the source cell. The early measurement report may include measurements related to the source cell and multiple target cells (e.g., which may be neighbor cells of the UE). The multiple target cells may include a number of target cells such as a first target cell, a second target cell, a third target cell, etc. The source cell and the multiple target cells may be intra/inter frequency and/or inter-RAT cells.

The UE may transmit capability information to the source cell, which may indicate a capability of the UE to support transmission of early SRSs to the target cells.

The UE may transmit to the source cell an uplink data interruption duration of the source cell, which may be related to the transmission of the early SRSs to the target cells.

The UE may transmit to the source cell a downlink data interruption duration of the source cell, which may be related to the transmission of the early SRSs to the target cells.

As indicated at 910 and 915, the source cell decides to use LTM and initiates LTM preparation with some target cells such as the first target cell and the second target cell. For example, the first target cell and the second target cell may indicate their SRS configurations (e.g., a transmission power, a bandwidth, etc.) to the source cell.

As indicated at 920, the source cell transmits a radio resource control (RRC) reconfiguration message to the UE. In response to receiving the RRC reconfiguration message, the UE may transmit an RRC reconfiguration complete message to the source cell.

The RRC reconfiguration message may include configurations and identifiers of the multiple target cells (e.g., the first target cell, the second target cell). The UE may store the configurations of the multiple target cells.

The RRC reconfiguration message may include an early SRS transmission configuration associated with each of the multiple target cells (e.g., the first target cell, the second target cell). For example, based on the capability information of the UE, the source cell configures the early SRS transmission configurations for the LTM for the multiple target cells.

In one example, the early SRS transmission configuration for each target cell may indicate a transmission power for the early SRSs to each target cell.

In another example, the early SRS transmission configuration for each target cell may indicate one or more uplink slots for the early SRSs to each target cell.

In another example, the early SRS transmission configuration for each target cell may indicate a bandwidth for the early SRSs to each target cell.

In another example, the early SRS transmission configuration for each target cell may indicate a timing advance (TA) value for the early SRSs to each target cell.

In another example, the early SRS transmission configuration for each target cell may indicate an uplink data interruption duration and/or a downlink data interruption duration of each target cell.

In certain aspects, the UE may transmit to the source cell a preference of target cells. For example, the preference may indicate the first target cell and the second target cell. In such cases, the source cell transmits to the UE the early SRS transmission configuration only for the first target cell and the second target cell.

As indicated at 925, the source cell, the first target cell, and the second target cell may exchange early SRS information.

As indicated at 930, the UE performs layer 1 (L1) measurements on the source cell and the multiple target cells, and transmits lower-layer measurement reports to the source cell. For example, the lower-layer measurement reports may include L1 reference signal receive power (RSRP) measurements for the source cell and the multiple target cells.

As indicated at 935, the source cell transmits to the UE first signaling triggering the UE to transmit the early SRSs to certain target cells (e.g., the second target cell. The first signaling may be a medium access control (MAC) control element (CE) or a downlink control information (DCI). For example, based on the capability information of the UE and/or the L1 RSRP measurements for the multiple target cells, the source cell may send early SRS MAC-CE to trigger the early SRS to the certain target cells.

The source cell may select the certain target cells that may have highest L1 RSRP measurement values for early SRS transmissions.

The first signaling may indicate a TA value, which may be based on an early uplink synchronization procedure at the UE, for the early SRS transmissions.

The first signaling may indicate an uplink TA value configured for the UE (e.g., UE-based uplink TA) for the early SRS transmissions.

In certain aspects, each target cell may be associated with multiple component carriers (CCs) including a primary CC (PCC) and a secondary CC (SCC). In such cases, the first signaling may indicate one or more CCs associated with the certain target cells (e.g., for the early SRS transmissions). For example, the early SRSs may be applicable for the PCC, the SCC, or both for uplink/downlink carrier aggregation (CA) for one step of CA handover.

In certain aspects, each target cell may be associated with a master cell group (MCG) or a secondary cell group (SCG). In such cases, the first signaling may indicate a cell group (CG) associated with the certain target cells (e.g., for the early SRS transmissions). For example, the early SRSs may be applicable for the MCG, the SCG or both for new radio NR dual connectivity for one step of new radio handover.

As indicated at 940, the UE sends the early SRS transmissions to the certain target cells indicated to the UE (e.g., the second target cell while the UE is connected to the source cell), as per the received TA value and in accordance with the early SRS transmission configuration for the second target cell.

As indicated at 945, all target cells (e.g., the second target cell) that receive the early SRS transmissions from the UE may perform uplink signal to interference plus noise ratio (SINR), precoding matrix indicator (PMI) and other measurements, based on the received early SRS transmissions. Each of these target cells may then send their SRS-based measurements to the source cell.

Each of these target cells may also determine and send uplink and downlink grant information to the source cell, based on the received early SRS transmissions. The uplink and downlink grant information may include modulation and coding scheme (MCS) values, PMI values, time domain resource allocation (TDRA), frequency domain resource allocation (FDRA), etc.

As indicated at 950, the UE transmits lower-layer measurement reports to the source cell. For example, the lower-layer measurement reports may include L1 RSRP measurements for the source cell and the multiple target cells.

As indicated at 955, the source cell determines to handover the UE from the source cell to the second target cell, which may be selected from the multiple target cells. For example, the source cell may select the second target cell based on uplink signal data and downlink signal data associated with the second target cell. The uplink signal data and the downlink signal data associated with the second target cell may be based on the lower-layer measurement reports.

The uplink signal data may include an uplink SINR associated with the second target cell.

The downlink signal data may include a downlink SINR associated with the second target cell, a downlink RSRP value associated with the second target cell, and/or a downlink reference signal received quality (RSRQ) value associated with the second target cell.

The source cell decides to execute LTM cell switch to the second target cell, and transmits a second signaling carrying a LTM switch command to the UE that may trigger the LTM cell switch to the second target cell. The second signaling may be a MAC-CE or a DCI. The UE switches to the second target cell, based on the LTM switch command.

In one example, the second signaling may indicate downlink grant information associated with the second target cell before the handover has been completed.

In another example, the second signaling may indicate uplink grant information associated with the second target cell before the handover has been completed.

In another example, the second signaling may indicate a timing schedule for transmitting uplink data to the second target cell after the handover has been completed.

In another example, the second signaling may indicate a timing schedule for receiving downlink data from the second target cell after the handover has been completed.

In another example, the second signaling may indicate time intervals for uplink and downlink grants associated with the second target cell.

In another example, the second signaling may indicate MCS and multiple input multiple output (MIMO) layer values based on the early SRS measurements.

As indicated at 960, the second target cell sends a physical downlink control channel (PDCCH) to the UE. The PDCCH may indicate dynamic or configured uplink grant and/or semi persistent scheduling (SPS) downlink grant (e.g., the MCS and MIMO layer values based on the early SRS measurements).

As indicated at 965, the UE transmits regular SRS transmissions to the second target cell. The second target cell sends uplink and downlink grant information to the UE, based on the regular SRS transmissions.

### Example Method for Wireless Communications

FIG. 10 shows an example of a method 1000 for wireless communications at a wireless node such as a user equipment (UE). For example, the UE may be the UE 104 of FIG. 1 and FIG. 3.

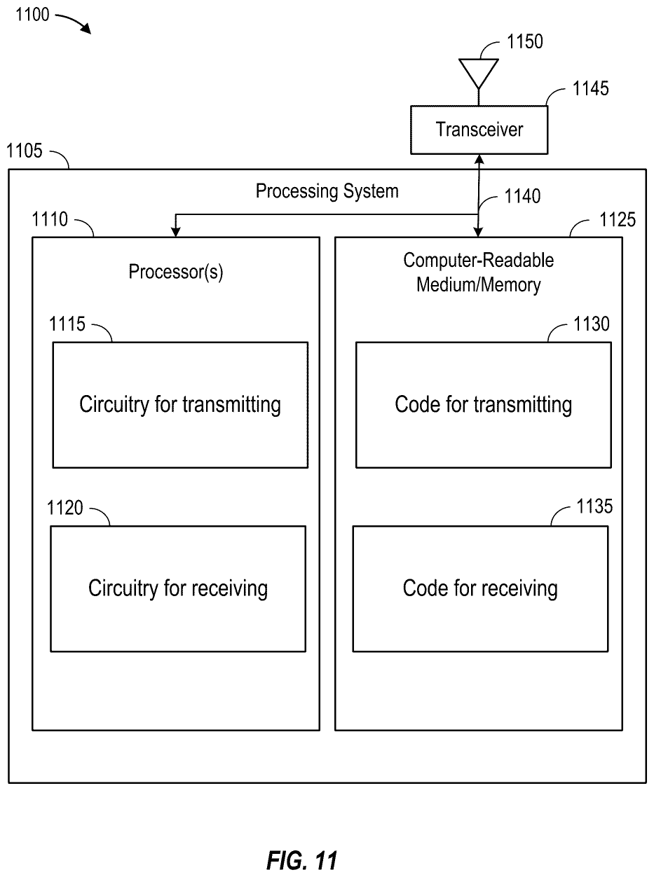

Method 1000 begins at 1010 with transmitting, to a source cell, measurements for the source cell and/or a set of neighbor cells. In some cases, the operations of this step refer to, or may be performed by, circuitry for transmitting and/or code for transmitting as described with reference to FIG. 11.

Method 1000 then proceeds to 1020 with receiving, from the source cell after transmitting the measurements, first signaling triggering the UE to transmit early sounding reference signals (SRSs) to one or more neighbor cells of the set of neighbor cells. In some cases, the operations of this step refer to, or may be performed by, circuitry for receiving and/or code for receiving as described with reference to FIG. 11.

Method 1000 then proceeds to 1030 with transmitting the early SRSs to the one or more neighbor cells (e.g., while the UE may communicate with the source cell). In some cases, the operations of this step refer to, or may be performed by, circuitry for transmitting and/or code for transmitting as described with reference to FIG. 11.

In certain aspects, the first signaling may include a medium access control (MAC) control element (CE) or a downlink control information (DCI).

In certain aspects, the method 1000 further includes transmitting UE capability information indicating a capability of the UE to support transmission of the early SRSs to the one or more neighbor cells, an uplink data interruption duration of the source cell related to the transmission of the early SRSs to the one or more neighbor cells, and/or a downlink data interruption duration of the source cell related to the transmission of the early SRSs to the one or more neighbor cells.

In certain aspects, the first signaling may indicate a timing advance (TA) value based on an early uplink synchronization procedure at the UE or an uplink TA value configured for the UE, for the early SRSs to the one or more neighbor cells.

In certain aspects, the method 1000 further includes receiving radio resource control (RRC) signaling indicating an early SRS transmission configuration for at least a subset of the set of neighbor cells indicating a transmission power for the early SRSs; one or more uplink slots for the early SRSs; a bandwidth for the early SRSs; and/or a TA value for the early SRSs.

In certain aspects, the method 1000 further includes transmitting the early SRSs to the one or more neighbor cells in accordance with the early SRS transmission configuration.

In certain aspects, the method 1000 further includes receiving, from the source cell, second signaling carrying a mobility command indicating a handover of the UE from the source cell to a first neighbor cell selected from the one or more neighbor cells based on uplink signal data and downlink signal data associated with the first neighbor cell.

In certain aspects, the uplink signal data may include an uplink signal to interference plus noise ratio (SINR) associated with the first neighbor cell. The downlink signal data may include a downlink SINR associated with the first neighbor cell, a downlink reference signal received power (RSRP) value associated with the first neighbor cell, and/or a downlink reference signal received quality (RSRQ) value associated with the first neighbor cell.

In certain aspects, the second signaling may include a MAC-CE or a DCI.

In certain aspects, the second signaling may indicate downlink grant information associated with the first neighbor cell and/or uplink grant information associated with the first neighbor cell.

In certain aspects, the second signaling may indicate a timing schedule for transmitting uplink data to the first neighbor cell and/or receiving downlink data from the first neighbor cell.

In certain aspects, the measurements for the source cell and/or the set of neighbor cells may include layer 1 (L1) RSRP measurements for the source cell and/or the set of neighbor cells.

In certain aspects, the method 1000 further includes receiving, from the source cell, a MAC-CE or a physical downlink control channel (PDCCH) triggering early antenna switching at the UE for transmission of the early SRSs. For example, based on UE capability, the source cell may transmit to the UE the MAC-CE or the PDCCH triggering early SRS antenna switching to a target cell and the target cell performs downlink scheduling based on early SRS antenna switching measurement for downlink multiple input multiple output (MIMO).

In certain aspects, the method 1000 further includes transmitting, to the source cell, a preference of a subset of the set of neighbor cells for an early SRS transmission configuration; and receiving RRC signaling indicating the early SRS transmission configuration for the subset of the set of neighbor cells indicating a transmission power for the early SRSs; one or more uplink slots for the early SRSs; a bandwidth for the early SRSs; and/or a TA value for the early SRSs.

In certain aspects, each of the set of neighbor cells may be associated with multiple component carriers (CCs) including at least a primary CC (PCC) and a secondary CC (SCC). The first signaling indicates one or more CCs associated with each of the one or more neighbor cells for transmission of the early SRSs.

In certain aspects, each of the set of neighbor cells may be associated with a master cell group (MCG) or a secondary cell group (SCG). The first signaling indicates a cell group (CG) associated with each of the one or more neighbor cells for transmission of the early SRSs.

In one aspect, the method 1000, or any aspect related to it, may be performed by an apparatus, such as a communications device 1100 of FIG. 11, which includes various components operable, configured, or adapted to perform the method 1000. The communications device 1100 is described below in further detail.

Note that FIG. 10 is just one example of a method, and other methods including fewer, additional, or alternative steps are possible consistent with this disclosure.

### Example Communications Device

FIG. 11 depicts aspects of an example communications device 1100. In some aspects, the communications device 1100 may be a user equipment (UE), such as UE 104 described above with respect to FIG. 1 and FIG. 3.

The communications device 1100 includes a processing system 1105 coupled to a transceiver 1145 (e.g., a transmitter and/or a receiver). The transceiver 1145 is configured to transmit and receive signals for the communications device 1100 via an antenna 1150, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1125 via a bus 1140. In certain aspects, the computer-readable medium/memory 1125 is configured to store instructions (e.g., computer-executable code) that when executed by the one or more processors 1110, cause the one or more processors 1110 to perform the method 1000 described with respect to FIG. 10, and/or any aspect related to it. Note that reference to a processor performing a function of communications device 1100 may include the one or more processors 1110 performing that function of communications device 1100.

In the depicted example, the computer-readable medium/memory 1125 stores code (e.g., executable instructions), such as code for receiving (or obtaining) 1135 and/or code for transmitting (or outputting) 1130. Processing of the code for receiving 1135 and/or the code for transmitting 1130 may cause the communications device 1100 to perform the method 1000 described with respect to FIG. 10, and/or any aspect related to it.

The one or more processors 1110 include circuitry configured to implement (e.g., execute) the code stored in the computer-readable medium/memory 1125, including circuitry such as circuitry for receiving (or obtaining) 1120 and/or circuitry for transmitting (or outputting) 1115. Processing with the circuitry for receiving 1120 and/or the circuitry for transmitting 1115 may cause the communications device 1100 to perform the method 1000 described with respect to FIG. 10, and/or any aspect related to it.

Various components of the communications device 1100 may provide means for performing the method 1000 described with respect to FIG. 10, and/or any aspect related to it.

For example, means for transmitting, sending or outputting (e.g., for transmission) may include transceivers 354 and/or antenna(s) 352 of the UE 104 illustrated in FIG. 3 and/or the code for transmitting 1130, the circuitry for transmitting 1115, the transceiver 1145 and the antenna 1150 of the communications device 1100 in FIG. 11. Means for receiving or obtaining may include transceivers 354 and/or antenna(s) 352 of the UE 104 illustrated in FIG. 3 and/or the code for receiving 1135, the circuitry for receiving 1120, the transceiver 1145 and the antenna 1150 of the communications device 1100 in FIG. 11.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 11 is an example, and many other examples and configurations of communication device 1100 are possible.

### Example Clauses

Implementation examples are described in the following numbered clauses:
Clause 1: A method for wireless communications at a user equipment (UE), comprising: transmitting, to a source cell, measurements for at least one of: the source cell or a set of neighbor cells; receiving, from the source cell after transmitting the measurements, first signaling triggering the UE to transmit early sounding reference signals (SRSs) to one or more neighbor cells of the set of neighbor cells; and transmitting the early SRSs to the one or more neighbor cells while the UE communicates with the source cell.
Clause 2: The method of clause 1, wherein the first signaling comprises a medium access control (MAC) control element (CE) or a downlink control information (DCI).
Clause 3: The method of any one of clauses 1-2, further comprising transmitting UE capability information indicating at least one of: a capability of the UE to support transmission of the early SRSs to the one or more neighbor cells, an uplink data interruption duration of the source cell related to the transmission of the early SRSs to the one or more neighbor cells, or a downlink data interruption duration of the source cell related to the transmission of the early SRSs to the one or more neighbor cells.
Clause 4: The method of any one of clauses 1-3, wherein the first signaling indicates a timing advance (TA) value based on an early uplink synchronization procedure at the UE or an uplink TA value configured for the UE, for the early SRSs to the one or more neighbor cells.
Clause 5: The method of any one of clauses 1-4, further comprising receiving radio resource control (RRC) signaling indicating an early SRS transmission configuration for at least a subset of the set of neighbor cells indicating at least one of: a transmission power for the early SRSs; one or more uplink slots for the early SRSs; a bandwidth for the early SRSs; or a timing advance (TA) value for the early SRSs.
Clause 6: The method of clause 5, wherein the transmitting comprises transmitting the early SRSs to the one or more neighbor cells in accordance with the early SRS transmission configuration.
Clause 7: The method of any one of clauses 1-6, further comprising receiving, from the source cell, second signaling carrying a mobility command indicating a handover of the UE from the source cell to a first neighbor cell selected from the one or more neighbor cells based on uplink signal data and downlink signal data associated with the first neighbor cell.
Clause 8: The method of clause 7, wherein: the uplink signal data comprises an uplink signal to interference plus noise ratio (SINR) associated with the first neighbor cell; and the downlink signal data comprises at least one of: a downlink SINR associated with the first neighbor cell, a downlink reference signal received power (RSRP) value associated with the first neighbor cell, or a downlink reference signal received quality (RSRQ) value associated with the first neighbor cell.
Clause 9: The method of clause 7, wherein the second signaling comprises a medium access control (MAC) control element (CE) or a downlink control information (DCI).
Clause 10: The method of clause 7, wherein the second signaling indicates at least one of: downlink grant information associated with the first neighbor cell or uplink grant information associated with the first neighbor cell.
Clause 11: The method of clause 7, wherein the second signaling indicates a timing schedule for at least one of: transmitting uplink data to the first neighbor cell or receiving downlink data from the first neighbor cell.
Clause 12: The method of any one of clauses 1-11, wherein the measurements for at least one of: the source cell or the set of neighbor cells comprise layer 1 (L1) reference signal receive power (RSRP) measurements for at least one of: the source cell or the set of neighbor cells.
Clause 13: The method of any one of clauses 1-12, further comprising receiving, from the source cell, a medium access control (MAC) control element (CE) or a physical downlink control channel (PDCCH) triggering early antenna switching at the UE for transmission of the early SRSs.
Clause 14: The method of any one of clauses 1-13, further comprising transmitting, to the source cell, a preference of a subset of the set of neighbor cells for an early SRS transmission configuration; and receiving radio resource control (RRC) signaling indicating the early SRS transmission configuration for the subset of the set of neighbor cells indicating at least one of: a transmission power for the early SRSs; one or more uplink slots for the early SRSs; a bandwidth for the early SRSs; or a timing advance (TA) value for the early SRSs.
Clause 15: The method of any one of clauses 1-14, wherein each of the set of neighbor cells is associated with multiple component carriers (CCs) comprising at least a primary CC (PCC) and a secondary CC (SCC); and the first signaling indicates one or more CCs associated with each of the one or more neighbor cells for transmission of the early SRSs.
Clause 16: The method of any one of clauses 1-15, wherein each of the set of neighbor cells is associated with a master cell group (MCG) or a secondary cell group (SCG); and the first signaling indicates a cell group (CG) associated with each of the one or more neighbor cells for transmission of the early SRSs.
Clause 17: An apparatus, comprising: at least one memory comprising instructions; and one or more processors configured, individually or in any combination, to execute the instructions and cause the apparatus to perform a method in accordance with any one of Clauses 1-16.
Clause 18: An apparatus, comprising means for performing a method in accordance with any one of Clauses 1-16.
Clause 19: A non-transitory computer-readable medium comprising executable instructions that, when executed by one or more processors of an apparatus, cause the apparatus to perform a method in accordance with any one of Clauses 1-16.
Clause 20: A computer program product embodied on a computer-readable storage medium comprising code for performing a method in accordance with any one of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
at least one memory comprising instructions; and
one or more processors, individually or collectively, configured to execute the instructions and cause the apparatus to:
transmit, to a source cell, measurements for at least one of: the source cell or a set of neighbor cells;
receive, from the source cell after transmitting the measurements, first signaling triggering the UE to transmit early sounding reference signals (SRSs) to one or more neighbor cells of the set of neighbor cells; and
transmit the early SRSs to the one or more neighbor cells while the UE is connected with the source cell.

2. The apparatus of claim 1, wherein the first signaling comprises a medium access control (MAC) control element (CE) or a downlink control information (DCI).

3. The apparatus of claim 1, wherein the one or more processors, individually or collectively, are configured to execute the instructions and cause the apparatus to transmit UE capability information indicating at least one of:
a capability of the UE to support transmission of the early SRSs to the one or more neighbor cells,
an uplink data interruption duration of the source cell related to the transmission of the early SRSs to the one or more neighbor cells, or
a downlink data interruption duration of the source cell related to the transmission of the early SRSs to the one or more neighbor cells.

4. The apparatus of claim 1, wherein the first signaling indicates a timing advance (TA) value based on an early uplink synchronization procedure at the UE or an uplink TA value configured for the UE, for the early SRSs to the one or more neighbor cells.

5. The apparatus of claim 1, wherein the one or more processors, individually or collectively, are configured to execute the instructions and cause the apparatus to receive radio resource control (RRC) signaling indicating an early SRS transmission configuration for at least a subset of the set of neighbor cells indicating at least one of:
a transmission power for the early SRSs;
one or more uplink slots for the early SRSs;
a bandwidth for the early SRSs; or
a timing advance (TA) value for the early SRSs.

6. The apparatus of claim 5, wherein the transmit comprises transmit the early SRSs to the one or more neighbor cells in accordance with the early SRS transmission configuration.

7. The apparatus of claim 1, wherein the one or more processors, individually or collectively, are configured to execute the instructions and cause the apparatus to receive, from the source cell, second signaling carrying a mobility command indicating a handover of the UE from the source cell to a first neighbor cell selected from the one or more neighbor cells based on uplink signal data and downlink signal data associated with the first neighbor cell.

8. The apparatus of claim 7, wherein:
the uplink signal data comprises an uplink signal to interference plus noise ratio (SINR) associated with the first neighbor cell; and
the downlink signal data comprises at least one of: a downlink SINR associated with the first neighbor cell, a downlink reference signal received power (RSRP) value associated with the first neighbor cell, or a downlink reference signal received quality (RSRQ) value associated with the first neighbor cell.

9. The apparatus of claim 7, wherein the second signaling comprises a medium access control (MAC) control element (CE) or a downlink control information (DCI).

10. The apparatus of claim 7, wherein the second signaling indicates at least one of:
downlink grant information associated with the first neighbor cell or uplink grant information associated with the first neighbor cell.

11. The apparatus of claim 7, wherein the second signaling indicates a timing schedule for at least one of: transmitting uplink data to the first neighbor cell or receiving downlink data from the first neighbor cell.

12. The apparatus of claim 1, wherein the measurements for at least one of: the source cell or the set of neighbor cells comprise layer 1 (L1) reference signal receive power (RSRP) measurements for at least one of: the source cell or the set of neighbor cells.

13. The apparatus of claim 1, wherein the one or more processors, individually or collectively, are configured to execute the instructions and cause the apparatus to receive, from the source cell, a medium access control (MAC) control element (CE) or a physical downlink control channel (PDCCH) triggering early antenna switching at the UE for transmission of the early SRSs.

14. The apparatus of claim 1, wherein the one or more processors, individually or collectively, are configured to execute the instructions and cause the apparatus to:
transmit, to the source cell, a preference of a subset of the set of neighbor cells for an early SRS transmission configuration; and
receive radio resource control (RRC) signaling indicating the early SRS transmission configuration for the subset of the set of neighbor cells indicating at least one of:
a transmission power for the early SRSs;
one or more uplink slots for the early SRSs;
a bandwidth for the early SRSs; or
a timing advance (TA) value for the early SRSs.

15. The apparatus of claim 1, wherein:
each of the set of neighbor cells is associated with multiple component carriers (CCs) comprising at least a primary CC (PCC) and a secondary CC (SCC); and
the first signaling indicates one or more CCs associated with each of the one or more neighbor cells for transmission of the early SRSs.

16. The apparatus of claim 1, wherein:
each of the set of neighbor cells is associated with a master cell group (MCG) or a secondary cell group (SCG); and
the first signaling indicates a cell group (CG) associated with each of the one or more neighbor cells for transmission of the early SRSs.

17. A method for wireless communications at a user equipment (UE), comprising:
transmitting, to a source cell, measurements for at least one of: the source cell or a set of neighbor cells;
receiving, from the source cell after transmitting the measurements, first signaling triggering the UE to transmit early sounding reference signals (SRSs) to one or more neighbor cells of the set of neighbor cells; and
transmitting the early SRSs to the one or more neighbor cells while the UE is connected with the source cell.

18. The method of claim 17, wherein the first signaling comprises a medium access control (MAC) control element (CE) or a downlink control information (DCI).

19. The method of claim 17, further comprising transmitting UE capability information indicating at least one of:
a capability of the UE to support transmission of the early SRSs to the one or more neighbor cells,
an uplink data interruption duration of the source cell related to the transmission of the early SRSs to the one or more neighbor cells, or
a downlink data interruption duration of the source cell related to the transmission of the early SRSs to the one or more neighbor cells.

20. An apparatus for wireless communications at a user equipment (UE), comprising:
means for transmitting, to a source cell, measurements for at least one of: the source cell or a set of neighbor cells;
means for receiving, from the source cell after transmitting the measurements, first signaling triggering the UE to transmit early sounding reference signals (SRSs) to one or more neighbor cells of the set of neighbor cells; and
means for transmitting the early SRSs to the one or more neighbor cells while the UE is connected with the source cell.
